(19) United States
(12) Patent Application Publication
(10) Pub. No.: US 2005/0137906 A1
(43) Pub. Date: Jun. 23, 2005

(54) Computerized method and system, and computer program product for patient selection for a medical procedure

(76) Inventors: Martin Kleen, Neunkirchen (DE); Norbert Rahn, Forchheim (DE)

Correspondence Address: SCHIFF HARDIN, LLP;PATENT DEPARTMENT, 6600 SEARS TOWER, CHICAGO, IL, 60606-6473, US

(21) Appl. No.: 10/743,586

(22) Filed: Dec. 22, 2003

(51) Int. Cl. G06F 17/60

(52) U.S. Cl. 705/2

(57) ABSTRACT

In a computerized method, system and computer program product for patient selection first, using a number of sample data sets that contain medical data describing a patient as well as at least one probability of success and one duration of a medical treatment, a decision tool is created and made available to a computer. The computer is then supplied with an input data set by a user that contains medical data describing a patient. Using the decision tool, the computer determines a corresponding expected output data set that contains at least one expected probability of success and one expected duration of a medical treatment, and makes this available as an output to the user.

### BACKGROUND OF THE INVENTION

1. Field of the Invention

The present invention concerns a computerized method for patient selection for a medical procedure.

The present invention also concerns a data carrier, with a computer program to implement such a method stored on the data carrier.

The present invention furthermore concerns a computer with a main memory in which a computer program is stored, such that such a method can be implemented upon calling of computer program by the computer.

2. Description of the Prior Art

Ablation procedures to eliminate pathological excitation centers or stimulus conductor paths in the heart are for the most part implemented today via HF ablation. In such ablations, typically a catheter is inserted into the body of the person via a large vein or artery, and then is guided into the affected heart chamber. HF energy is then locally applied in order to oblate the pathological tissue, and thus to interrupt the pathological excitation centers or stimulus conductor paths.

In the case of pulmonary vein isolation that is intended to treat atrial fibrillation and atrial flutter, the ablation procedure shows that the pathological stimulus conductor paths run from the pulmonary vein via myocardial fibers in the left atrium. The results in the atrial contraction being incorrectly produced—sometimes with a frequency of over 200 contraction cycles per minute. The goal of the pulmonary vein isolation is to electro-physiologically isolate the four pulmonary veins from the left atrium. This ensues by circular HF ablation in the ostium of the pulmonary veins. Additionally, in specific patients with atrial fibrillation, with the help of the HF ablation a linear lesion is generated that runs along an imaginary connecting line of the four pulmonary veins with the mitral valve.

HF ablation is a difficult procedure. It has a success rate of only approximately 60% to 70%. Furthermore, in the isolation of the pulmonary veins, a not-insignificant risk exists that stenoses in the pulmonary veins will occur. The as to decision whether a pulmonary vein isolation should be implemented on a specific patient is therefore requires, among other consideration, a balancing of the possible chances for success against the possible risks.

### SUMMARY OF THE INVENTION

An object of the present invention is to provide a computerized method for patient selection, by means of which a patient selection in a simple and safe manner, particularly in the case of risky procedures. The inventive solution to this problem is described herein the context of the problem of pulmonary vein isolation, however it is universally applicable beyond this, such that the solution can be implemented generally.

The above object is achieved by a computerized method for patient selection in accordance with the invention wherein first a decision tool is created using a number of sample data sets, and the decision tool is made available to a computer, each sample data set including both medical data describing a patient and at least one probability of success and one duration of the medical procedure in question, the computer is then supplied with an input data set by a user that contains medical data describing a patient, and using the decision tool, the computer determines an expected output data set, corresponding with the input data set, that contains at least one expected probability of success and one expected duration of the medical treatment, and makes this available as an output to the user.

When the number of sample data sets that are used to generate the development tool is at least multiple hundreds, in particular over a thousand, a particularly reliable conclusion about the treatment duration and the change of success is possible using the decision tool.

The decision tool in principle can be arbitrarily fashioned, however, it is preferably fashioned as an expert system, as a neural network or as a static formulation.

In an embodiment wherein the computer can verify the decision tool after the generation with a number of test data sets, the method for patient selection is safer.

In an embodiment wherein the output data set are made available to the computer for payment—in particular via a computer network, for example the World Wide Web—an incentive exists for the owner to make such data sets available to the operator of the method for patient selection.

A constant updating of the decision tool is possible in a simple manner in an embodiment wherein the computer buffers the input data set; and a corresponding actual output data set is transferred from the user to the computer at a later point in time that contains an actual probability of success and an actual duration of a medical treatment; and the computer modifies the decision tool using the input data set and the corresponding actual output data set.

In an embodiment wherein the computer accepts the input data set only for a fee, and/or only outputs the output data set to the user for a fee, an amortization of the development expenditure for the creation of the decision tool is achieved in a simple manner.

In an embodiment wherein the fee for the acceptance of an individual input data set, or for the output of the corresponding expected output data set, is dependent on the number of input data sets transmitted by the user, a type of volume discount can be achieved in a simple manner.

In an embodiment wherein the fee decreases due to the transmission of the corresponding actual output data set, an inducement exists for the user to also make data available to the operator of the method after the implementation of the procedure, beyond the start phase (meaning the creation of the decision tool).

### DESCRIPTION OF THE DRAWINGS

FIG. 1 schematically illustrates a computer network for implementing the invention.

FIG. 2 is a flow chart showing the basic steps of the invention.

FIG. 3 shows a data set produced in accordance with the invention.

### DESCRIPTION OF THE PREFERRED EMBODIMENTS

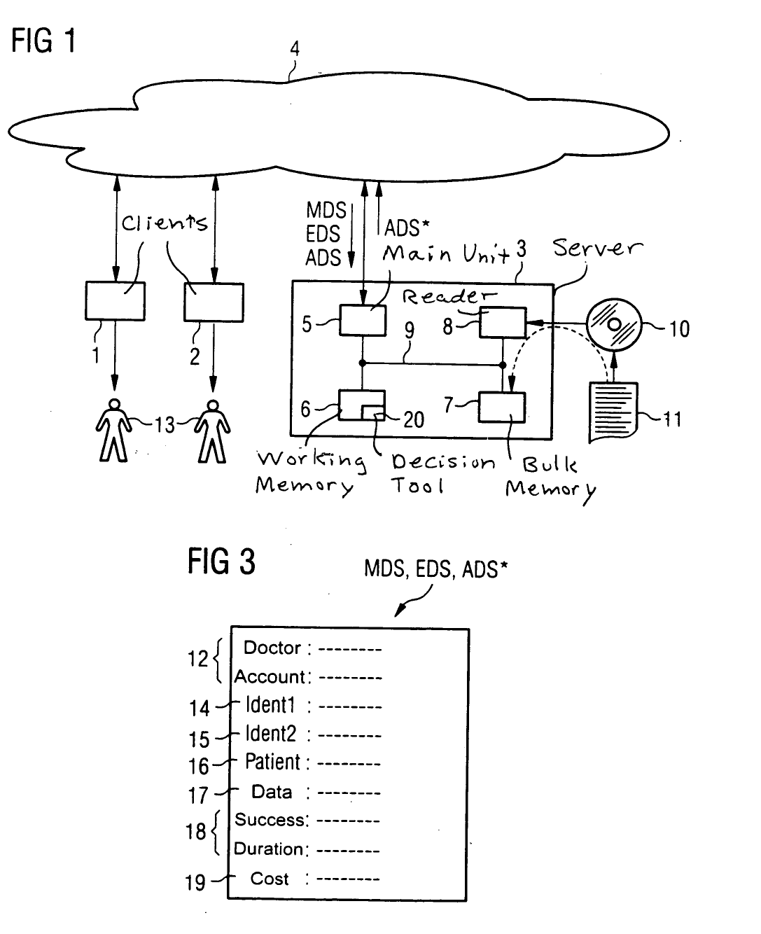

As shown in FIG. 1, two clients 1, 2 and a server 3 are connected with one another via a computer network 4. The computer network 4 can be specially developed, but it is preferably the World Wide Web. The clients 1, 2 are fashioned as typical user computers. Therefore no further description thereof is necessary.

The server 3 likewise has typical components 5 through 8. The components 5 through 8 in particular are main units, a working memory 6, a bulk storage 7, and a reader device 8. The bulk storage 7, for example, is fashioned as a fixed disk 7, the drive 8 is fashioned as a CD-ROM or DVD drive 8. The components 5 through 8 are connected with one another in a typical manner via a bus 9.

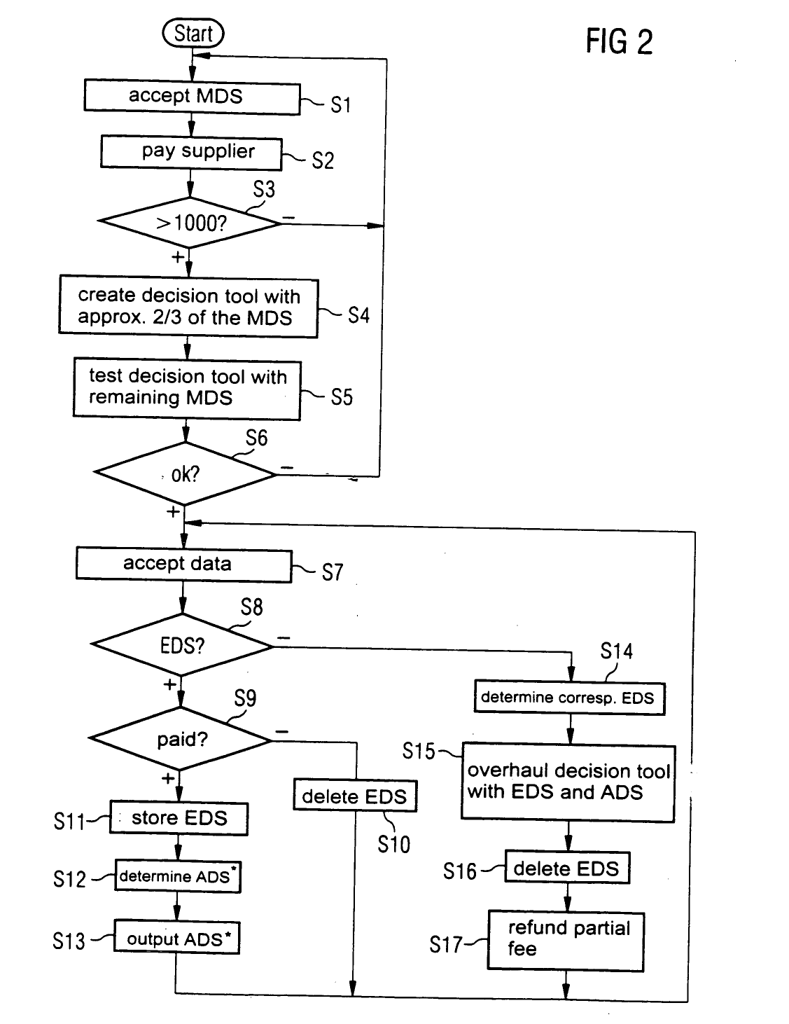

A data medium (carrier) 10 can be inserted into the reader device 8, for example a CD-ROM 10. A computer program 11 is stored on the data medium 10 in (exclusively) machine-readable format. The computer program 11 is read by the reader device 8 and stored in the bulk storage 7 of the server 3. Upon calling the computer program 11, the server 3 is thereby able to execute a method for patient selection that is described in detail in connection with FIG. 2.

According to FIG. 2, in a step S1 the server 3 first accepts a sample data set from one of the clients 1, 2. The sample data set MDS has the following content according to FIG. 3:
Specifications 12 about the respective users 13 of the client 1, 2. The specifications 12 comprise, for example, one name of a doctor, his or her address, as well as his or her bank data.
First and second identification codes 14, 15. The first identification code 14 thereby serves, for example, for the repeated identification of the user 13; the second identification code 15 serves for the identification of the further transferred data 16 through 18.
The further data 16 through 18 include a patient identification 16, descriptive medical data 17 about this patient, as well as all data 18 about the duration and the success of the effected medical treatment.

In the present case, the medical treatment is an ablation procedure, in particular an HF ablation procedure to eliminate pathological excitation centers and stimulus conductor paths of the human heart, in particular for pulmonary vein isolation. The medical data 17 in particular are cardiologically-relevant data such as, for example, EKG curves, blood-fat levels, blood-sugar levels, and so forth. specifications such as age, size, weight of the patient and the like are also included in the data 16.

In a step S2, a cost field 19 is filled out by the server 3 and the data set MDS is then sent back to the user 13. Also in the framework of the step S2, by online banking a bank transfer to the specified bank account of the user 13 is initiated. The sample data set MDS therefore is made available to the server 3 for a fee.

In a step S3, the server 3 then checks whether the total number of the sample data sets MDS transmitted to it exceeds a predetermined limit value, for example 1000. When this is not the case, it returns to step S1. Alternatively, it continues the execution of the method with a step S4. For completeness, it is should be noted that naturally another limit value than the number 1000 can be tested for. The number of the required sample data sets MDS, however, always should be more than a hundred.

In step S4, a decision tool 20 is created and is made available (accessible by) to the server 3. For example, this can ensue by (as shown in FIG. 1) the decision tool 20 being likewise stored in the bulk storage 7 of the server 3. The decision tool 20 (see FIG. 1) for example, can be fashioned as an expert system, as a neural network, as a static estimate, etc.

The creation of the decision tool 20 preferably ensues with only a part of the sample data sets MDS, for example with approximately two-thirds of the sample data sets MDS. The rest of the sample data sets MDS can thereby be used to verify the decision tool 20 in a step S5. The remaining sample data sets MDS, thus approximately one-third of the sample data sets MDS, can this be used as a test data set MDS with which the server 3 verifies the decision tool 20 after its creation.

In a step S6, the server 3 then tests whether the verification of the step S5 was successful. If it was successful, it proceeds with a step S7. Otherwise, it jumps back to step S1 in order to expand the knowledge base for creation of the decision tool 20, thus to increase the number of sample data sets MDS—for example, by about 20%.

In step S7, the server 3 accepts data from one of the clients 1, 2. The server 3 first tests, in a directly subsequent step S8, whether the transmitted data is an input data set EDS. When this is the case, the server 3 tests in a step S9 whether a fee can be debited from the specified bank account of the user 13. When this is not the case, in a step S10 the server 3 deletes the transmitted input data set EDS and goes back to step S7.

When the debiting of the fee was successful, in a step S11 the server 3 buffers the input data set EDS. The buffering alternatively can ensue in the working storage 6 or in the mass storage 7. An input data set EDS thereby substantially corresponds to a sample data set MDS specified in connection with FIG. 3. However, the fields for the data 18 for the duration and the probability of success of the medical treatment are empty in this case.

In a step S12, the server 3 then determines, using the decision tool 20, an expected output data set ADS* and outputs it to the user 13 via the computer network 4. The expected output data set ADS* includes at least one expected probability of success and one expected duration of a medical treatment. The output data set ADS* preferably corresponds to the data set shown in FIG. 3. For example, the server 3 can expand the further data 18 and then sent the data set back to the user 13. The server 3 then returns to the step S7.

As a result, via the procedure of the steps S9 through S13, it is thus (among other things) also achieved that the server 3 only accepts the input data set EDS for a fee, or only outputs the corresponding expected output data set ADS* to the user 13 for a fee.

If no input data set EDS was transmitted to the computer in step S7, the transmitted data, in accordance with the present invention, can only be an output data set ADS. An output data set ADS contains at least the identification code 15, with which the corresponding input data set EDS already previously transmitted can be determined, as well as an actual probability of success 18 and an actual duration 18 of the medical treatment. In a step 14, the server 3 therefore is able to first determine this corresponding input data set EDS. The determined input data set EDS and the actual output data set ADS transmitted henceforth (thus at a later point in time) by the user 13 therefore can be used by the server 3 in a step S16 to overhaul the decision tool 20 using the input data set EDS and the corresponding actual output data set ADS.

In a step S17, the server 3 then initiates a partial refund of the fee whose payment was checked in step S9. As a result, the fee for the acceptance of the input data set EDS is this reduced based on the transmission of the corresponding actual output data set ADS.

The procedure specified above represents the preferred embodiment of the present invention. Variations of the invention are possible. In particular, it is possible to apply it to other medical treatments other than ablation procedures. The fee to be paid by the user 13, or the fees to be paid to the user 13, can also be dependent on many types of factors. In particular, it is for example possible for the fee for the acceptance of an individual input data set EDS or for the output of the corresponding expected output data set ADS* to depend on the number of the input data sets EDS transmitted by the user 13, so it can be graduated.

Although modifications and changes may be suggested by those skilled in the art, it is the intention of the inventors to embody within the patent warranted hereon all changes and modifications as reasonably and properly come within the scope of their contribution to the art.

1. A computerized method for selecting a patient for a medical procedure, comprising the steps of:
creating a decision tool using a plurality of sample data sets, and making said decision tool available to a computer;
in each of said sample data sets, including medical data describing a patient and a probability of success of a medical procedure and a duration of said medical procedure;
entering an input data set from a user into the computer, and including in said input data set medical data describing a candidate patient under consideration for said medical procedure; and
using said decision tool in said computer, determining an expected output data set corresponding with said input data set, including an expected probability of success of said medical procedure for said candidate patient and an expected duration of said medical procedure for said candidate patient, and making said expected output data set available to the user.

2. A method as claimed in claim 1 comprising using sample data sets for an HF ablation procedure, as said medical procedure for eliminating pathological excitation centers.

3. A method as claimed in claim 1 comprising using sample data sets for an HF ablation procedure, as said medical procedure, for elimination of stimulus conductor paths.

4. A method as claimed in claim 1 comprising using sample data sets for an HF ablation procedure, as said medical treatment, for pulmonary vein isolation.

5. A method as claimed in claim 1 comprising using a plurality of sample data sets numbering at least multiple hundreds.

6. A method as claimed in claim 1 comprising using a plurality of sample data sets numbering over a thousand.

7. A method as claimed in claim 1 comprising using a decision tool selected from the group consisting of expert systems, neural networks, and static estimates.

8. A method as claimed in claim 1 comprising after creating said decision tool, verifying said decision tool in said computer using a plurality of test data sets.

9. A method as claimed in claim 1 comprising making said sample data set available to said computer for a fee via a computer network accessible by said computer.

10. A method as claimed in claim 9 comprising making said sample data set available to said computer via the worldwide web.

11. A method as claimed in claim 1 comprising the additional steps of:
buffering said input data set in said computer;
making an actual output data set available to said computer and including in said actual output data set an actual probability of success of said medical procedure for said candidate patient and an actual duration of said medical procedure for said candidate patient; and
in said computer, revising said decision tool using said input data set and said actual output data set.

12. A method as claimed in claim 1 comprising allowing said computer to perform at least one of accepting said input data set and emitting said expected output data set only upon substantiation of payment of a fee.

13. A method as claimed in claim 12 comprising setting said fee dependent on a number of said input data sets entered by said user.

14. A method as claimed in claim 12 comprising the additional steps of:
buffering said input data set in said computer;
making an actual output data set available to said computer and including in said actual output data set an actual probability of success of said medical procedure for said candidate patient and an actual duration of said medical procedure for said candidate patient;
in said computer, revising said decision tool using said input data set and said actual output data set; and
reducing said fee upon said user making said actual output data set available to said computer.

15. A computer program product for selecting a patient for a medical procedure, loadable into a computer for programming said computer to:
create a decision tool using a plurality of sample data sets, and in each of said sample data sets, include medical data describing a patient and a probability of success of a medical procedure and a duration of said medical procedure;
receive an input data set from a user including medical data describing a candidate patient under consideration for said medical procedure; and
using said decision tool in, determine an expected output data set corresponding with said input data set, including an expected probability of success of said medical procedure for said candidate patient and an expected duration of said medical procedure for said candidate patient, and make said expected output data set available to the user as an output.

16. A computer program product as claimed in claim 15 wherein said computer is further programmed by said computer program product to verify, after creating said decision tool, said decision tool in said computer using a plurality of test data sets.

17. A computer program product as claimed in claim 15 wherein said computer is further programmed by said computer program product to:
buffer said input data set in said computer;
receive an actual output data set including an actual probability of success of said medical procedure for said candidate patient and an actual duration of said medical procedure for said candidate patient; and
revise said decision tool using said input data set and said actual output data set.

18. A computer program product as claimed in claim 15 wherein said computer is further programmed by said computer program product to allow said computer to perform at least one of accepting said input data set and emitting said expected output data set upon substantiation of payment of a fee.

19. A computer program product as claimed in claim 18 wherein said computer is further programmed by said computer program product to set said fee dependent on a number of said input data sets entered by said user.

20. A computer program product as claimed in claim 18 wherein said computer is further programmed by said computer program product to:
buffer said input data set in said computer;
receive an actual output data set from a user including an actual probability of success of said medical procedure for said candidate patient and an actual duration of said medical procedure for said candidate patient;
revise said decision tool using said input data set and said actual output data set; and
reduce said fee upon said user making said actual output data set available to said computer.

21. A computer for selecting a patient for a medical procedure programmed to:
create a decision tool using a plurality of sample data sets including medical data describing a patient and a probability of success of a medical procedure and a duration of said medical procedure;
receive an input data set from a user including medical data describing a candidate patient under consideration for said medical procedure; and
using said decision tool, determine an expected output data set corresponding with said input data set, including an expected probability of success of said medical procedure for said candidate patient and an expected duration of said medical procedure for said candidate patient, and make said expected output data set available to the user as an output.

22. A computer as claimed in claim 21 further programmed to verify, after creating said decision tool, said decision tool using a plurality of test data sets.

23. A computer as claimed in claim 21 further programmed to:
buffer said input data set in said computer;
receive an actual output data set including an actual probability of success of said medical procedure for said candidate patient and an actual duration of said medical procedure for said candidate patient; and
revise said decision tool using said input data set and said actual output data set.

24. A computer as claimed in claim 21 further programmed to allow performance of at least one of accepting said input data set and emitting said expected output data set only upon substantiation of payment of a fee.

25. A computer as claimed in claim 24 further programmed to set said fee dependent on a number of said input data sets entered by said user.

26. A computer as claimed in claim 24 further programmed to:
buffer said input data set in said computer;
receive an actual output data set including an actual probability of success of said medical procedure for said candidate patient and an actual duration of said medical procedure for said candidate patient;
revise said decision tool using said input data set and said actual output data set; and
reduce said fee upon said user making said actual output data set available to said computer.
